(19) United States
(12) Patent Application Publication
(10) Pub. No.: US 2025/0238816 A1
(43) Pub. Date: Jul. 24, 2025

(54) METHOD AND SYSTEM FOR AUTHENTICATION OF AS-BUILT ENGINEERING DRAWINGS USING BLOCKCHAIN TECHNOLOGY

(71) Applicant: SAUDI ARABIAN OIL COMPANY, Dhahran (SA)

(72) Inventors: Abdullah ALFURAYDI, Dhahran (SA); Abdulaziz ALMUHAISIN, Dhahran (SA); Ahmed ALZAHRANI, Dhahran (SA)

(73) Assignee: SAUDI ARABIAN OIL COMPANY, Dhahran (SA)

(21) Appl. No.: 18/419,367

(22) Filed: Jan. 22, 2024

(51) Int. Cl. G06Q 30/018; G06F 21/60

(52) U.S. Cl. CPC G06Q 30/0185; G06F 21/602

(57) ABSTRACT

An engineering drawing integrity safeguarding system includes a database for storing engineering drawings, a plurality of nodes, including creator and reviewer nodes, providing access to the engineering drawings, and a blockchain framework through which said access is governed, the blockchain framework operable to propagate changes through nodes of the plurality of nodes and to perform hashing, authentication and verification of the engineering drawings.

### FIELD OF THE DISCLOSURE

The present disclosure relates generally to safeguarding the integrity of multiply-accessed engineering drawings.

### BACKGROUND OF THE DISCLOSURE

The review and approval process for engineering drawings is a crucial segment in the designing phase for any engineering project. The process involves an intricate and collaborative effort where engineers, architects, administrators, and regulators can perform one or more of evaluate, edit, revise, and provide comments and analysis on engineering drawings as they develop from rough drafts to final products. This process is important for many reasons, such as ensuring compliance with code enforcement from various agencies and governments, shaving exorbitant costs that may otherwise have incurred from mistakes in the building stage, and assessing the feasibility of the plan and the availability of resources or materials required to complete it. The process is further complicated by requiring access from many parties from different organizations and varying international locations with differing laws.

Currently absent from these processes are central system controls, whether internal or external, that secure, encrypt, and verify updates in the review process, and then propagate those updates in real-time to authorized parties and the rest of the review and approval chain. Such a control system would add transparency and accuracy to the process, and cut down on time-consuming communication between the many varying parties. Comprehensive and synchronized reviews and approvals will enhance a smooth flow of the design and building processes, which often consist of tight schedules where a single day's delay could incur large costs and inconveniences.

Blockchain technology is a shared, immutable ledger that facilitates the process of tracking assets and recording transactions. Changes in assets are recorded in blocks, encrypted into a coded “hash.” These blocks are then chained together in an immutable sequence, identified by their respective hashes, and creating a secured ledger. Blockchain technology provides immediate, shared, and transparent information stored on such a ledger that can be accessed only by permissioned network members. These permissions may be wholly public for the sake of transparency, or wholly private for the sake of security and accuracy. A blockchain network can track orders, payments, accounts, production, and other advanced processes. Because members share a single view of the truth, one can see all details of a process or transaction from beginning to end, providing greater confidence, as well as new efficiencies and opportunities.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter. According to an embodiment consistent with the present disclosure, an engineering drawing integrity safeguarding system includes a database for storing engineering drawings, a plurality of nodes, including creator and reviewer nodes, providing access to the engineering drawings, and a blockchain framework through which said access is governed, the blockchain framework operable to propagate changes through nodes of the plurality of nodes and to perform hashing, authentication and verification of the engineering drawings. In another embodiment, a method for authenticating at least one engineering drawing performed by a blockchain framework includes recording one or more drawings and drawing metadata from the drawings, updating a plurality of nodes on the blockchain framework with a change in the drawing or drawing metadata during a drawing review process, and analyzing recorded drawing metadata and forecasting a set of next steps in the drawing review process.

In another embodiment, a machine-readable storage medium having stored thereon a computer program for authenticating at least one engineering drawing performed by a blockchain framework. The computer program includes a routine of set instructions for causing the machine to perform the steps of recording one or more drawings and drawing metadata from the drawings, updating a plurality of nodes on the blockchain framework with a change in the drawing or drawing metadata during a drawing review process, analyzing recorded drawing metadata and forecasting a set of next steps in the drawing review process.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a block diagram of an example of an engineering drawing integrity safeguarding system.

FIG. 2 is a block diagram depicting an example of an implementation of an engineering drawing integrity safeguarding system using a blockchain framework according to certain embodiments.

FIG. 3 is a flow diagram depicting an example method for authenticating at least one engineering drawing performed by a blockchain framework.

FIG. 4 is a flow diagram depicting an example method for a drawing review process.

FIG. 5 is a diagram of an example of a blockchain framework.

FIG. 6 is a block diagram of a computer system that may be used to implement one or more of the systems or methods described herein in accordance with certain embodiments.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to safeguarding the integrity of multiply-accessed engineering drawings.

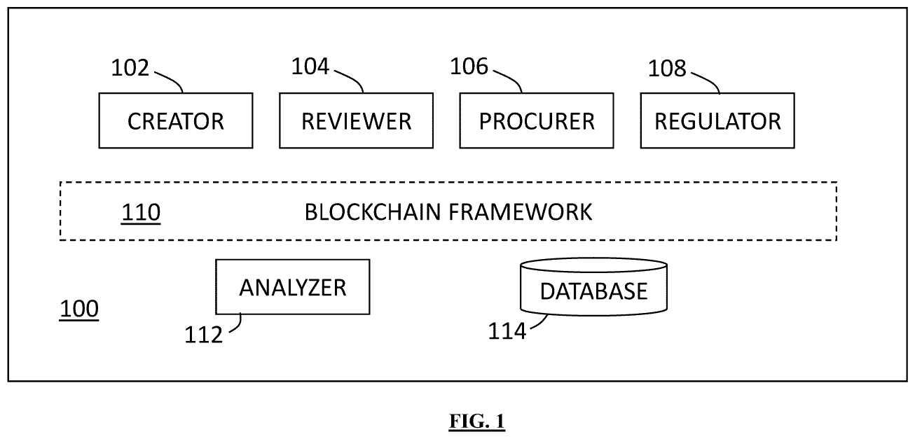

FIG. 1 is a block diagram of an engineering drawing integrity safeguarding system 100 using blockchain technology in accordance with certain embodiments. System 100 includes a creator node 102, a reviewer node 104, a procurer node 106, and a regulator node 108 that overly a blockchain framework 110. Also included is an analyzer 112 and a data repository (e.g. database) 114 for storing engineering drawings input through the creator or other nodes, as well as other data and metadata relating to the drawings and the various system users and accounts as described herein. The creator node 102 is configured to receive at least one drawing from an engineer. The creator node may be accessible via any user-operable computing device capable of receiving an engineering drawing and then relaying that drawing to one or more components. For example, it may include one or more computing devices selected from, for example, a desktop computer, a server, a controller, a blade, a mobile phone, a tablet, a laptop computer, a hashing computer, a personal digital assistant (PDA), and the like. A drawing can be any schematic relevant to the design and engineering process, including but not limited to, drawings by hand, hand drawings uploaded digitally via a scanner or other means, digital drawings, drawings created through computer-generated imagery, CAD (computer aided design) drawings, and the like. These drawings may be uploaded and relayed in any format, such as, but not limited to, a .PDF, .JPEG, PNG, .DOC, .SVG, and the like, or may be contained within .ZIP files. Drawings are uploaded to the interface by engineers, or otherwise users and persons with engineering or administrative authorizations, including but not limited to, personal assistants, architects, and supervisors. In one embodiment, the creator node 102 may be an application or applet, located on any user-operable computing device, as described above.

The reviewer node 104 is configured to receive one or more drawings from the creator node 102 to be reviewed by a reviewer, providing one or more drawing revisions. The reviewer node may be any user-operable computing device capable of receiving an engineering drawing and then relaying that drawing and any changes or edits to the specifications of that drawing to the rest of the system. These devices may include one or more computing devices selected from, for example, a desktop computer, a server, a controller, a blade, a mobile phone, a tablet, a laptop computer, a hashing computer, a personal digital assistant (PDA), and the like. A drawing revision may include any form of collaborative editing, revising, or approval of such. For example, a reviewer may view a first draft of a drawing and provide comments for changes, make the changes themselves, pass on instructions to others for changes, ask questions regarding the design, or simply approve the draft as-is. Changes or updates can include any form of revision that facilitates bringing the drawings closer to their final drafts. For example, the reviewer may leave comments or questions on a draft, mark up the draft by hand to point out issues or rectify errors, add or subtract units or assets from the drawings, and the like. Drawings are reviewed at the reviewer node 104 by reviewers, or otherwise users and persons with reviewing or administrative authorizations, including but not limited to supervisors, other engineers or architects, administrators, or regulators. In one embodiment, the reviewer node 104 may be an application or applet, located on any user-operable computing device, as described above.

The analyzer 112 is operable to collect drawing metadata from the drawing and drawing revisions, analyze that data, and then forecast a set of requirements for a set of next phases of an engineering project. The analyzer 112 may exist in the form of software or hardware located on an internal or external server (not shown). Drawing metadata may include any information relevant to current or future engineering phases that may be derived from the drawings or drawing revisions in order to prepare for those phases as efficiently as possible. This data may be specific to each and every drawing. For example, drawing metadata may contain drawing master data, a history of the drawing's document management, including dates and times of revisions and the identity or location of the entity who made such revisions; it may identify a number of required building materials, the quantity of each of those building materials, and the estimated costs of all said materials. Master data may be used for smart comparison or other automated functionalities. This information can be analyzed manually, by a supervisor or administrator in charge of procurement, to determine if a design is perhaps too costly or a resource too scarce. This information may then be used to determine and relay further changes to the revision and approval process, or to begin procuring the required materials earlier on in the process. This information may also be analyzed by a computer process or algorithm, which may cross reference listed materials and prices against inventories or availability ledgers and project budgets and relay alerts about issues, or to automatically send orders to procurement divisions to acquire the required materials. Other examples of information or data specific to the corresponding engineering drawings may also include important dates or deadline for the engineering project, or changing volumes of orders of materials.

The procurer node 106 is configured to receive the drawings, the drawing revisions, the drawing metadata, and the set of requirements for the next phases in order to procure materials for the project. For example, the analyzer 112 may parse an engineering drawing to require a certain amount of steel beams to build, costing a certain amount of money per beam. Upon approval by reviewers, this analysis may be relayed to the procurer node 106, accessible by a procurement department, to begin processes to obtain the steel beams. In another example, the analysis may be sent to the procurer node 106 to read that the design is not feasible, as the materials it requires are currently too expensive or scarce.

The database 114 is configured to store one or more drawings, drawing revisions, and drawing metadata for access to and from one or more of the creator node 102, the reviewer node 104, the procurer node 106, the analyzer 112, and the blockchain framework 110.

The blockchain framework 110 is configured to encrypt and synchronize the drawing revisions across one or more nodes. The drawings and drawing revisions may take the form of the examples listed above. Encryption may include any method by which information is converted into a secured code that hides the information's true meaning. These encryptions may include formulas to encode and decode the information, such as encryption algorithms or ciphers. These encryptions may include various keys, and these keys may have varying levels of access corresponding to different levels of authority of a user with access to such a key. For example, a senior level administrator may have access to a key that decodes all encrypted information. In another example, a lower level reviewer may have access to a key that only decodes the drawings and any information relating to its revisions and current revising status. Synchronization of information may include secured and verifiable changes, updating in real-time across the system. For example, a reviewer may provide comments on a drawing via their reviewer-authorized-access to the blockchain platform. The comments may be marked with a specific reviewer signature, to internally verify their authenticity. These comments would update in real time and display to an engineer through the engineer's authorized access to the blockchain platform. The engineer would not only see these comments quickly, but they would know the comments are accurate, verified, and secure via the blockchain platform's ingrained smart verification.

Blockchain framework 110 may include a shared, immutable ledger (not shown). This shared, immutable ledger may take the form of a connected chain of any number of blocks, herein referred to as a blockchain. Blocks may be any change in an asset, recorded and stored in a block. These blocks link and chain securely together, which prevent any block from being altered or deleted, or another block being inserted in between. For example, a drawing reviewer opens a drawing, makes a minor revision, and then closes the drawing. The act of opening the drawing, the revision, and the closing of the drawing, are all recorded in individual blocks and chained together to form a ledger, assuming no other asset changes occurred during this time. The exact timing of these asset changes and sequences may also be recorded, as well as other information such as the identity of who performed the actions, and so on.

As described above, a blockchain framework may also include a varying number of nodes such as the creator node 102, reviewer node 104, procurer node 106, and regulator node 108 described above. These nodes may be configured to allow varying degrees of access based on varying degrees of authorization. Authorizations and their corresponding access may be used by users through portals. Changes to assets within the blockchain via the nodes may be propagated throughout the platform and reflected in real-time through the other nodes. These changes to assets, or blocks, may occur in the form of a hash. A hash may be any function that converts an input of letters and numbers into an encrypted output of a fixed length. For example, a first drawing may be submitted to the blockchain platform, this drawing and its metadata will serve as a first hash, such as a deterministic hexadecimal number. This hash serves as a blockchain identifier.

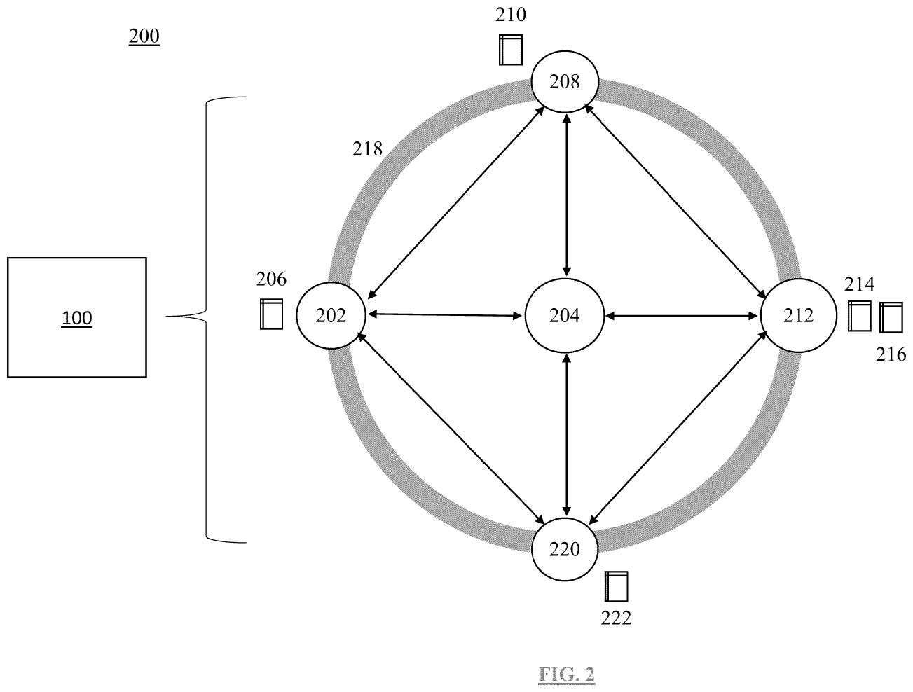

FIG. 2 is a block diagram depicting an example of an implementation of an engineering drawing integrity safeguarding system using a blockchain framework 200, which may correspond to the blockchain framework 110 described above, according to certain embodiments. Blockchain framework 200 includes a creator node 202 configured to store drawing information 204 and a creator signature 206; a reviewer node 208 configured to store drawing information 204 and a reviewer signature 210; a procurer node 212 configured to store drawing information 204, engineering tag data 214, and a procurement signature 216; and a blockchain 218, configured to record and hash the drawing information 204 in a set of blocks, and connects the creator node 202, the drawing reviewer node 208, and the procurer node 212 through a network.

The creator node 202 can store various pieces of drawing information 204, including but not limited to, a drawing identification, a link to the drawing, a hash of the drawing, a list of materials the engineering project the drawing represents would require to build, the status of the drawing and its review or approval, and a creator signature 206. The creator signature 206 can be any form of identifying function that allows access to the blockchain platform 200 via the creator node 202. This identifying function may be in the form of a blockchain key or decoder, or a tag on a user profile which identifies authorization. Such signatures or tags may also be used to label drawings or changes to drawings as verified, viewable by other users on other nodes. For example, the reviewer may be able to see that an incoming drawing was verified by an appropriate creator tag or signature, and thus trust its accuracy and proceed to reviewing. A creator node 202 may be accessed through a creator portal. In one embodiment, an engineer can submit the frame and specification of an engineering drawing through a creator portal to which the engineer has authorization. This drawing may carry with it various metadata such as the type of the drawing, the drawing ID, the drawing status, and relevant standards based on a specific engineering contract. This information may be encrypted via a first hash.

The drawing reviewer node 204 can store various pieces of drawing information 204, including but not limited to, a drawing identification, a link to the drawing, a hash of the drawing, a list materials the engineering project the drawing represents would require to build, the status of the drawing and its review or approval, and a reviewer signature 210. The reviewer signature 210 can be any form of identifying function that allows access to the blockchain platform 200 via the reviewer node 208. This identifying function may be in the form of a blockchain key or decoder, or a tag on a user profile which identifies authorization. Such signatures or tags may also be used to label drawings or changes to drawings as verified, viewable by other users on other nodes. For example, an engineer may be able to see that changes to a drawing were verified by an appropriate reviewer tag or signature, and thus trust its accuracy and be able to proceed. A drawing node 208 may also be accessed through a reviewer portal. In one embodiment, a stored first hash of a drawing's information may be circulated through the system for reviews and approval. A reviewer's signature after each review or comment or remark may update the hash after each subsequent modification, and the updated hash will be propagated throughout all nodes to all parties.

The procurer node 212 can store various pieces of drawing information 204, including but not limited to, a procurement request identification, a drawing identification, a link to the drawing, a hash of the drawing, a list of materials to purchase, the status of the drawing and its review or approval, and a procurement signature 216. The procurement signature 216 may be any form of identifying function that allows access to the blockchain platform 200 via the procurer node 212. This identifying function may be in the form of a blockchain key or decoder, or a tag on a user profile which identifies authorization. Such signatures or tags may also be used to label drawings or changes to drawings as verified, viewable by other users on other nodes. For example, an administrator may be able to see that material costs corresponding to a draft drawing were verified by an appropriate procurement tag or signature, and thus be able to proceed with oversight. A procurer node 212 may be accessed through a procurement portal. In one embodiment, drawing information 204 and its corresponding hash and a procurement signature 216 may be stored in the procurer node 212 in order to generate a list of the most recommended or most demanded materials for the future engineering project or contract. Any updates may be reflected in the hash, and propagated throughout all nodes to all parties. This may provide anticipation for procurement to determine the type and magnitude of future budgets.

In an embodiment, blockchain framework 200 may also include a regulator node 220, including a regulator permission tag 222, configured to facilitate end-to-end supervision by at least one regulator to monitor project status and ensure compliance with laws, regulations requirements and the like. For example, in an engineering project for a government or larger projects where governmental supervision is required, an additional node for these regulators, or other external third-parties, may be provided to review evidence of compliance with relevant laws, such as various building codes or data protection standards. A regulator permission tag may be any form of identifying function that allows access to the blockchain platform 200 via the regulator node 220. This identifying function may be in the form of a blockchain key or decoder, or a tag on a user profile which identifies authorization. Such signatures or tags may also be used to label drawings or changes to drawings as verified, viewable by other users on other nodes. For example, reviewer may be able to see that changes to a drawing were approved by an appropriate reviewer tag or signature, and thus trust the accuracy of that approval and be able to proceed in the revision process. Updates and approvals via a regulator node 220 will also be reflected in the hash and then propagated throughout all node to all parties. A regulator node may be accessed through a regulator portal.

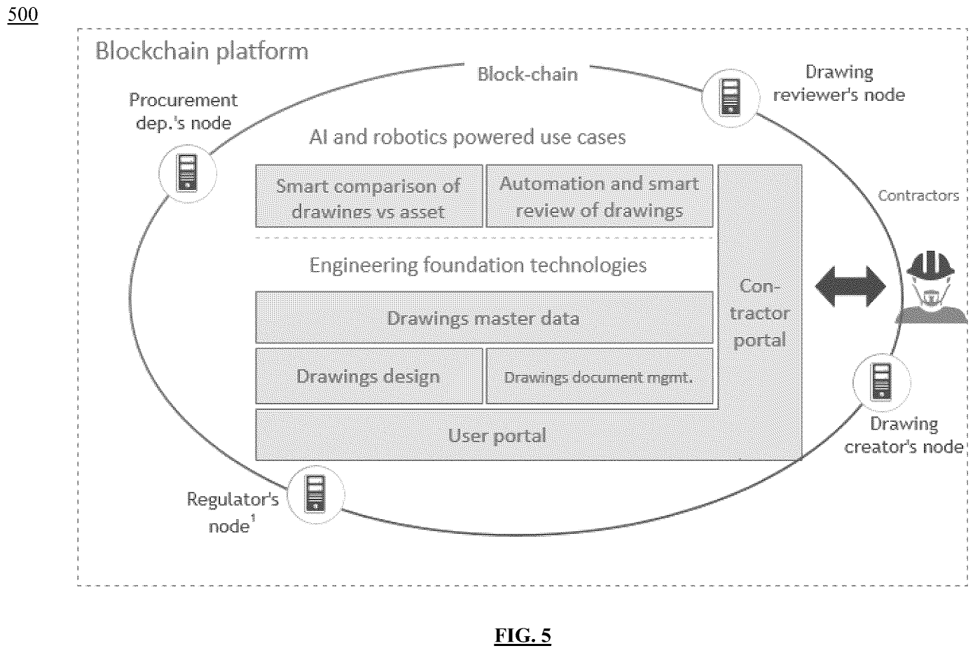

FIG. 5 is a diagram depicting an example of a blockchain framework 500, which may correspond to the blockchain framework 200 and blockchain framework 110 described above, according to one embodiment. In this embodiment, drawing information includes Artificial Intelligence (A.I.) and robotics powered use cases, smart comparisons of drawings versus assets, automation and smart review of drawings, engineering foundation technologies, drawings master data, drawings designs, and drawing document management. In some embodiments, A.I. may be utilized to streamline several processes, including but not limited to detecting differences between as-built engineering drawings and real physical buildings, reviewing as-built designs to detect anomalies in the designs, and suggesting improvements to the designs. In some embodiments, robotics may be used to scan buildings for physical changes in the structure. Robots may also provide input to the A.I. to analyze such changes, by signaling and alerting the need to correct the drawings and then suggesting the changes that should be implemented. The creator node may also include a creator portal. The regulator node may also include a user portal.

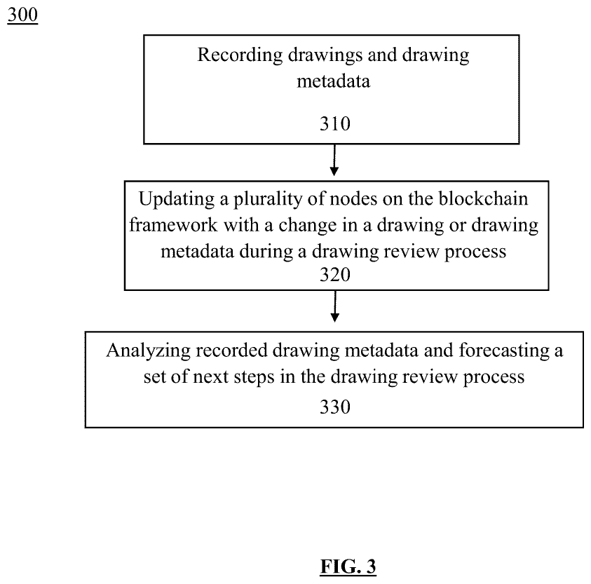

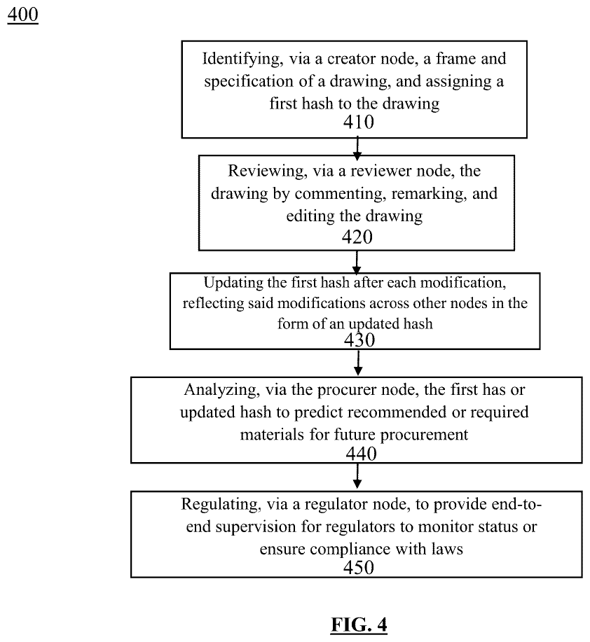

In view of the structural and functional features described above, example methods will be better appreciated with reference to FIGS. 1-2. While, for purposes of simplicity of explanation, the example methods of FIGS. 3-4 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

FIG. 3 is flowchart diagram depicting an example of a method 300 for authenticating at least one engineering drawing performed by a blockchain framework. The method 300 can be implemented by engineering drawing integrity safeguarding system 100 and blockchain framework 200, as shown in FIGS. 1-2. Thus, reference can be made to the example of FIGS. 1-2 in the example of FIG. 3.

Method 300 includes recording one or more drawings and drawing metadata from the drawing at step 310, updating a plurality of nodes on the blockchain framework 200 with a change in the drawing or drawing metadata during a drawing review process at step 320, and analyzing recorded drawing metadata and forecasting a set of next steps in the drawing review process at step 330.

In one embodiment depicted by flowchart diagram FIG. 4, the drawing review process 400 of method 300 may further include identifying, via a creator node, a frame and specification of a drawing, and assigning a first hash to the drawing at step 410; reviewing, via a reviewer node, the drawing by commenting, remarking, and editing the drawing at step 420; updating the first hash after each modification, reflecting said modifications across other nodes at step 430; analyzing, via the procurer node, the first hash or updated hash to predict recommended or required materials for future procurement at step 440; and regulating, via a regulator node, to provide end-to-end supervision for regulators to monitor status or ensure compliance with laws at step 450.

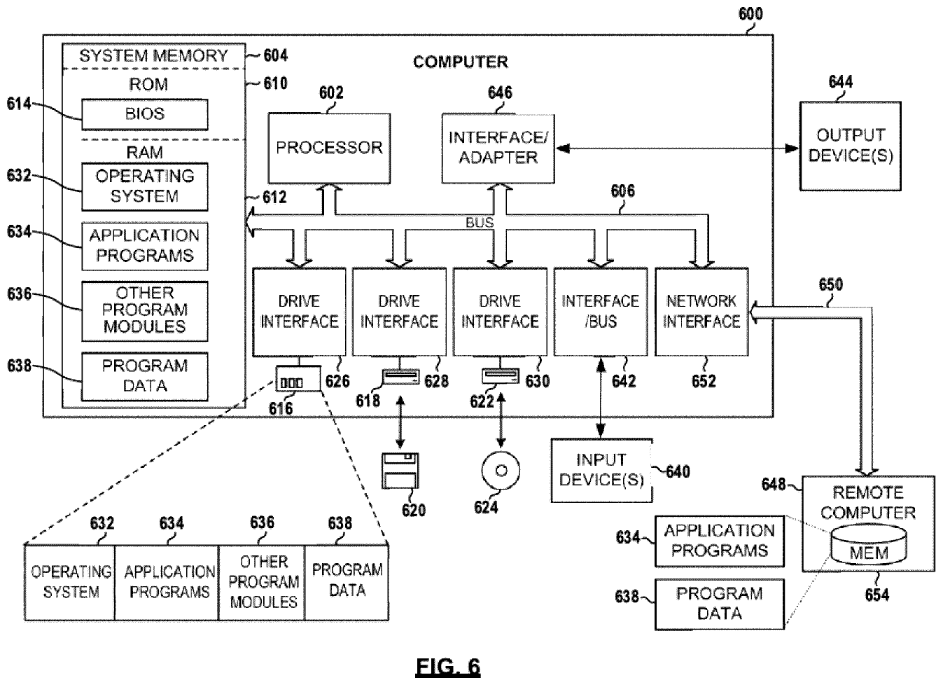

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 6. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 6 illustrates one example of a computer system 600 that can be employed to execute one or more embodiments of the present disclosure. Computer system 600 can be implemented on one or more general purpose networked computer systems, embedded computer systems, routers, switches, server devices, client devices, various intermediate devices/nodes or standalone computer systems. Additionally, computer system 600 can be implemented on various mobile clients such as, for example, a personal digital assistant (PDA), laptop computer, pager, and the like, provided it includes sufficient processing capabilities.

Computer system 600 includes processing unit 602, system memory 604, and system bus 606 that couples various system components, including the system memory 604, to processing unit 602. System memory 604 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 602. System bus 606 may be any of several types of bus structure including a memory bus or memory controller, a peripheral bus, and a local bus using any of a variety of bus architectures. System memory 604 includes read only memory (ROM) 610 and random access memory (RAM) 612. A basic input/output system (BIOS) 614 can reside in ROM 610 containing the basic routines that help to transfer information among elements within computer system 600.

Computer system 600 can include a hard disk drive 616, magnetic disk drive 618, e.g., to read from or write to removable disk 620, and an optical disk drive 622, e.g., for reading CD-ROM disk 624 or to read from or write to other optical media. Hard disk drive 616, magnetic disk drive 618, and optical disk drive 622 are connected to system bus 606 by a hard disk drive interface 626, a magnetic disk drive interface 628, and an optical drive interface 630, respectively. The drives and associated computer-readable media provide nonvolatile storage of data, data structures, and computer-executable instructions for computer system 600. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 610, including operating system 632, one or more application programs 634, other program modules 636, and program data 638, In some examples, the application programs 634 can include creator node 102, reviewer node 104, procurer node 106, regulator node 108 and analyzer 112, and the program data 638 can include the drawings and drawing revisions and metadata. The application programs 634 and program data 638 can include functions and methods programmed to implement an engineering drawing integrity safeguarding system using a blockchain framework, such as shown and described herein.

A user may enter commands and information into computer system 600 through one or more input devices 640, such as a pointing device (e.g., a mouse, touch screen), keyboard, microphone, joystick, game pad, scanner, and the like. For instance, the user can employ input device 640 to edit or modify the drawings. These and other input devices 640 are often connected to processing unit 602 through a corresponding port interface 642 that is coupled to the system bus, but may be connected by other interfaces, such as a parallel port, serial port, or universal serial bus (USB). One or more output devices 644 (e.g., display, a monitor, printer, projector, or other type of displaying device) is also connected to system bus 606 via interface 646, such as a video adapter.

Computer system 600 may operate in a networked environment using logical connections to one or more remote computers, such as remote computer 648. Remote computer 648 may be a workstation, computer system, router, peer device, or other common network node, and typically includes many or all the elements described relative to computer system 600. The logical connections, schematically indicated at 650, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 600 can be connected to the local network through a network interface or adapter 652. When used in a WAN networking environment, computer system 600 can include a modem, or can be connected to a communications server on the LAN. The modem, which may be internal or external, can be connected to system bus 606 via an appropriate port interface. In a networked environment, application programs 634 or program data 638 depicted relative to computer system 600, or portions thereof, may be stored in a remote memory storage device 654.

Embodiments disclosed herein include:

A. An engineering drawing integrity safeguarding system comprising: a database for storing engineering drawings; a plurality of nodes, including creator and reviewer nodes, providing access to the engineering drawings; and a blockchain framework through which said access is governed, the blockchain framework operable to propagate changes through nodes of the plurality of nodes and to perform hashing, authentication and verification of the engineering drawings.

B. A method for authenticating at least one engineering drawing performed by a blockchain framework, the method comprising: recording one or more drawings and drawing metadata from the drawings; updating a plurality of nodes on the blockchain framework with a change in the drawing or drawing metadata during a drawing review process; and analyzing recorded drawing metadata and forecasting a set of next steps in the drawing review process.

C. A machine-readable storage medium having stored thereon a computer program for authenticating at least one engineering drawing performed by a blockchain framework, the computer program comprising a routine set of instructions for causing the machine to perform the steps of: recording one or more drawings and drawing metadata from the drawings; updating a plurality of nodes on the blockchain framework with a change in the drawing or drawing metadata during a drawing review process; and analyzing recorded drawing metadata and forecasting a set of next steps in the drawing review process.

Each of embodiments A through C may have one or more of the following additional elements in any combination: Element 1: wherein the system further comprises a creator node configured to store drawing information and a creator signature; a reviewer node configured to store drawing information and a reviewer signature; and a procurer node configured to store drawing information, engineering tags data, and a procurement signature. Element 2: wherein the blockchain framework is configured to record and hash drawing metadata in a set of blocks. Element 3: wherein the blockchain framework is connected to one or more of the plurality of nodes through a cloud network. Element 4: wherein the blockchain framework further comprises artificial intelligence. Element 5: wherein the plurality of nodes includes a procurer node. Element 6: wherein the plurality of nodes include a regulator node, including a regulator permission tag, configured to facilitate end-to-end supervision by at least one regulator to monitor project status and ensure compliance with laws. Element 6: wherein the drawing review process further comprises identifying, via a creator node, a frame and specification of a drawing, and assigning a first hash to the drawing; reviewing, via a reviewer node, the drawing by commenting, remarking, and editing the drawing; updating the first hash after each modification, reflecting said modifications across other nodes as an updated hash; analyzing, via a procurer node, the first has or updated hash to predict recommended or required materials for future procurement; and regulating, via a regulator node, to provide end-to-end supervision for regulators to monitor status or ensure compliance with laws.

By way of non-limiting example, exemplary combinations applicable to A through C include: Element 1 with Element 2; Element 2 with Element 3; Element 3 with Element 4; Element 2 with Element 5; Element 1 with Element 6; Element 2 with Element 6; and Element 4 with Element 5.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. An engineering drawing integrity safeguarding system comprising:
a database for storing engineering drawings;
a plurality of nodes, including creator and reviewer nodes, providing access to the engineering drawings; and
a blockchain framework through which said access is governed, the blockchain framework operable to propagate changes through nodes of the plurality of nodes and to perform hashing, authentication and verification of the engineering drawings.

2. The system of claim 1, further comprising:
a creator node configured to store drawing information and a creator signature;
a reviewer node configured to store drawing information and a reviewer signature; and
a procurer node configured to store drawing information, engineering tag data, and a procurement signature.

3. The system of claim 1, wherein the blockchain framework is configured to record and hash drawing metadata in a set of blocks.

4. The system of claim 1, wherein the blockchain framework is connected to one or more of the plurality of nodes through a cloud network.

5. The system of claim 1, wherein the blockchain framework further comprises artificial intelligence.

6. The system of claim 1, wherein the plurality of nodes include a procurer node.

7. The system of claim 1, wherein the plurality of nodes include a regulator node, including a regulator permission tag, configured to facilitate end-to-end supervision by at least one regulator to monitor project status and ensure compliance with laws.

8. A method for authenticating at least one engineering drawing performed by a blockchain framework, the method comprising:
recording one or more drawings and drawing metadata from the drawings;
updating a plurality of nodes on the blockchain framework with a change in the drawing or drawing metadata during a drawing review process; and
analyzing recorded drawing metadata and forecasting a set of next steps in the drawing review process.

9. The method for authenticating at least one engineering drawing performed by a blockchain framework of claim 8, wherein the drawing review process further comprises:
identifying, via a creator node, a frame and specification of a drawing, and assigning a first hash to the drawing;
reviewing, via a reviewer node, the drawing by commenting, remarking, and editing the drawing;
updating the first hash after each modification, reflecting said modifications across other nodes as an updated hash;
analyzing, via a procurer node, the first hash or updated hash to predict recommended or required materials for future procurement; and
regulating, via a regulator node, to provide end-to-end supervision for regulators to monitor status or ensure compliance with laws.

10. The method of claim 8, wherein the blockchain framework is configured to record and hash drawing metadata in a set of blocks.

11. The method of claim 8, wherein the blockchain framework is connected to one or more of the plurality of nodes through a cloud network.

12. The method of claim 8, wherein the blockchain framework further comprises artificial intelligence.

13. The method of claim 8, wherein the plurality of nodes include a procurer node.

14. The method of claim 8, wherein the plurality of nodes further comprises a regulator node, including a regulator permission tag, configured to facilitate end-to-end supervision by at least one regulator to monitor project status and ensure compliance with laws.

15. A machine-readable storage medium having stored thereon a computer program for authenticating at least one engineering drawing performed by a blockchain framework, the computer program comprising a routine of set instructions for causing the machine to perform the steps of:
recording one or more drawings and drawing metadata from the drawings;
updating a plurality of nodes on the blockchain framework with a change in the drawing or drawing metadata during a drawing review process; and
analyzing recorded drawing metadata and forecasting a set of next steps in the drawing review process.

16. The machine-readable storage medium of claim 14, the set of instructions further causing the machine to perform the steps of:
identifying, via a creator node, a frame and specification of a drawing, and assigning a first hash to the drawing;
reviewing, via a reviewer node, the drawing by commenting, remarking, and editing the drawing;
updating the first hash after each modification, reflecting said modifications across other nodes as an updated hash;
analyzing, via a procurer node, the first hash or updated hash to predict recommended or required materials for future procurement; and
regulating, via a regulator node, to provide end-to-end supervision for regulators to monitor status or ensure compliance with laws.

17. The machine-readable storage medium of claim 14, wherein the blockchain framework is configured to record and hash drawing metadata in a set of blocks.

18. The machine-readable storage medium of claim 14, wherein the blockchain framework is connected to one or more of the plurality of nodes through a cloud network.

19. The machine-readable storage medium of claim 14, wherein the blockchain framework further comprises artificial intelligence.

20. The machine-readable storage medium of claim 14, wherein the plurality of nodes include a procurer node.

21. The machine-readable storage medium of claim 14, wherein the plurality of nodes further comprises a regulator node, including a regulator permission tag, configured to facilitate end-to-end supervision by at least one regulator to monitor project status and ensure compliance with laws.
